(19) United States
(12) Patent Application Publication
(10) Pub. No.: US 2006/0240142 A1
(43) Pub. Date: Oct. 26, 2006

(54) Clamping apparatus for injection molding machine

(76) Inventors: Sung-Chul Shin, Seoul (KR); Byeong-Geun Jang, Suwon-si (KR)

Correspondence Address: JONES DAY, 222 EAST 41ST ST, NEW YORK, NY, 10017, US

(21) Appl. No.: 11/409,397

(22) Filed: Apr. 21, 2006

(30) Foreign Application Priority Data
Apr. 25, 2005 (KR) 10-2005-0034210

(51) Int. Cl. B29C 45/66

(52) U.S. Cl. 425/595

(57) ABSTRACT

Disclosed is a clamping apparatus for an injection molding machine, which includes a frame; a first fixed die plate fixed to the frame and on which a first half mold is mounted; a tie bar fixed to a second fixed die plate to guide a moving die plate; the moving die plate slidably installed to the tie bar and on which a second half mold corresponding to the first half mold is mounted; a coupling means installed to a rear side of the moving die plate and coupling the moving die plate and the tie bar; the second fixed die plate installed to the tie bar at the front of the first fixed die plate; and at least one piston ram installed between the fixed die plates and selectively controlling a distance between the fixed die plates so that the half molds are closely adhered or separated.

### BACKGROUND OF THE INVENTION

1. Field of the Invention

The present invention relates to a clamping apparatus for an injection molding machine, and more particularly to a clamping apparatus for an injection molding machine, which may effectively apply a clamping force using a very small amount of pressurized oil so that a mold will not open during injection of a melted resin and which may be easily applied to a large injection molding machine.

2. Description of the Related Art

Generally, an injection molding machine includes an injection unit and a clamping unit. The injection unit melts resin and injects the resin melt by high pressure into a mold. The clamping unit is used for opening and closing the mold and combines the mold not to be opened by the high-pressure melted resin.

The clamping unit is classified into a toggle type, a direct pressure type and a hydro-mechanical type.

The toggle-type clamping unit includes a fixed die plate 12 on which a first half mold 11 is mounted, a moving die plate 14 moving along a tie bar 18 or other guides and on which a second half mold 13 corresponding to the first half mold 111 is mounted, and a tie bar 18 for guiding movement of the moving die plate 14, as shown in FIG. 1.

The toggle-type clamping unit 10 opens or closes the first and second half molds 11 and 13 when a toggle arm 17 is pivoted by means of reciprocation of a toggle piston ram 15, and the moving die plate 14 is moved right and left by means of pivoting of the toggle arm 17.

The toggle-type clamping unit 10 employs the principle of toggle, so the first and second half molds 11 and 13 may be rapidly opened or closed even using a small amount of pressurized oil.

However, the toggle-type clamping unit 10 disadvantageously requires much time to set an accurate clamping force. In addition, when the first and second half molds 11 and 13 are exchanged, a distance D between the moving die plate 14 and a support 19 should be adjusted depending on thickness of the first and second half molds 11 and 13. That is to say, the distance D between the moving die plate 14 and the support 19 should be adjusted by moving the support 19 or adjusting the length of the toggle arm 17.

The direct pressure type clamping unit opens and closes a mold by means of reciprocation of a piston. Thus, the direct pressure type clamping unit may easily set an accurate clamping force, and the problem of adjusting a length between the moving die plate 14 and the support 19 depending on the thickness of the mold may be solved.

However, the direct pressure type clamping unit requires a large volume of hydraulic cylinder and a large amount of pressurized oil as well as much energy consumption since it generates a clamping force only using the cylinder and piston. In addition, due to prefill valve and booster ram employed for increasing an opening and closing speed of the mold, the device become larger and complicated.

The hydro-mechanical clamping unit is designed to solve the above problems.

As shown in FIG. 2, the hydro-mechanical clamping unit 20 includes a fixed die plate 22 fixed to a base 21 and on which a first half mold 22a is mounted, a moving die plate 23 supported by a tie bar 29 to move a predetermined distance and on which a second half mold 23a corresponding to the first half mold 22a is mounted, a clamping cylinder 25 installed to a support 24 and in which a clamping ram 26 movable within a predetermined range is mounted, a first spline gear 28a mounted in the clamping ram 26 and connected to the moving die plate 23 by means of a shaft 27, and a second spline gear 28b mounted in the clamping ram 26 so as to be selectively engaged with the first spline gear 28a.

This hydro-mechanical clamping unit 20 is operated as follows.

First, the moving die plate 23 advances near to the fixed die plate 22 by means of an external force. At this time, the first and second spline gears 28a and 28b are positioned to cross each other as shown in FIG. 3. Then, the shaft 27 is rotated a predetermined angle so that the first spline gear 28a is engaged with the second spline gear 28b as shown in FIG. 4, and then pressurized oil is supplied into the clamping cylinder 25 to seal the mold and raise pressure therein.

However, since an engaged area of the first and second spline gears 28a and 28b is not wide, the hydro-mechanical clamping unit 20 has a limit in giving a clamping force for combining the mold. That is to say, the conventional hydro-mechanical clamping unit 20 has a problem that it may not easily applied to a large injection unit that needs a great clamping force.

### SUMMARY OF THE INVENTION

The present invention is designed to solve the problems of the prior art, and therefore it is an object of the present invention to provide a hydro-mechanical clamping apparatus for an injection molding machine, which may effectively apply a clamping force of a mold and reduce energy consumption by using a very small amount of pressurized oil.

Another object of the invention is to provide a hydro-mechanical clamping apparatus for an injection molding machine, which need not control a distance between a moving die plate and a support depending on thickness of a mold when the mold is exchanged.

Still another object of the invention is to provide a hydro-mechanical clamping apparatus for an injection molding machine, which may be easily applied to a large-sized injection molding machine requiring a big clamping force.

Further another object of the invention is to provide a hydro-mechanical clamping apparatus for an injection molding machine, which may easily set a desired clamping force by using a simple structure.

In order to accomplish the above object, the present invention provides a hydro-mechanical clamping apparatus for an injection molding machine, which includes a frame; a first fixed die plate fixed to the frame and on which a first half mold is mounted; a tie bar fixed to a second fixed die plate to guide a moving die plate; the moving die plate slidably installed to the tie bar and on which a second half mold corresponding to the first half mold is mounted; a coupling means installed to a rear side of the moving die plate and coupling the moving die plate and the tie bar; the second fixed die plate installed to the tie bar at the front of the first fixed die plate; and at least one piston ram installed to one of the first and second fixed die plates and selectively controlling a distance between the first and second fixed die plates so that the first and second half molds are closely adhered to each other or separated from each other.

Preferably, the hydro-mechanical clamping apparatus may further include a carrying member for sliding the moving die plate so that the second half mold approaches the first half mold.

More preferably, the carrying member includes a cylinder installed to the first fixed die plate; and a piston ram installed to the moving die plate.

Preferably, the coupling means includes a half nut installed to the moving die plate and having a first tooth of a predetermined shape formed on an inner side thereof; and a driving unit for selectively reciprocating the half nut with respect to the tie bar, wherein a second tooth to be engaged with the first tooth is formed on an outer circumference of the tie bar so that the first and second teeth are selectively engaged to couple the moving die plate to the tie bar.

Here, it is preferred that the piston ram is installed to a clamping cylinder prepared to one of the first and second fixed die plates, and oil ports are formed in the clamping cylinder so as to supply pressurized oil to the front and rear of the piston ram respectively.

Preferably, the hydro-mechanical clamping apparatus may further include a carrying member installed to the moving die plate and the second fixed die plate and guiding the moving die plate and the second fixed die plate to be capable of sliding with respect to the frame.

### BRIEF DESCRIPTION OF THE DRAWINGS

Other objects and aspects of the present invention will become apparent from the following description of embodiments with reference to the accompanying drawing in which:

FIG. 1 is a side view showing a toggle-type clamping unit according to the prior art;

FIG. 2 is a side view showing a hydro-mechanical clamping unit according to the prior art;

FIGS. 3 and 4 are sectional views respectively showing how a coupling unit using a spline gear in the hydro-mechanical clamping unit of FIG. 2 is operated;

FIGS. 5 to 7 are side views respectively showing how a hydro-mechanical clamping apparatus for an injection molding machine according to a preferred embodiment of the present invention is operated;

FIG. 8 is a sectional view showing a clamping cylinder of the hydro-mechanical clamping apparatus for an injection molding machine according to a preferred embodiment of the present invention, which is installed to a second fixed die plate; and

FIG. 9 is a sectional view showing a clamping cylinder of the hydro-mechanical clamping apparatus for an injection molding machine according to another embodiment of the present invention, which is installed to a second fixed die plate.

### DESCRIPTION OF THE PREFERRED EMBODIMENT

Hereinafter, the preferred embodiments of the present invention will be described in detail with reference to the accompanying drawings. Prior to the description, it should be understood that the terms used in the specification and appended claims should not be construed as limited to general and dictionary meanings, but interpreted based on the meanings and concepts corresponding to technical aspects of the present invention on the basis of the principle that the inventor is allowed to appropriately define terms for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

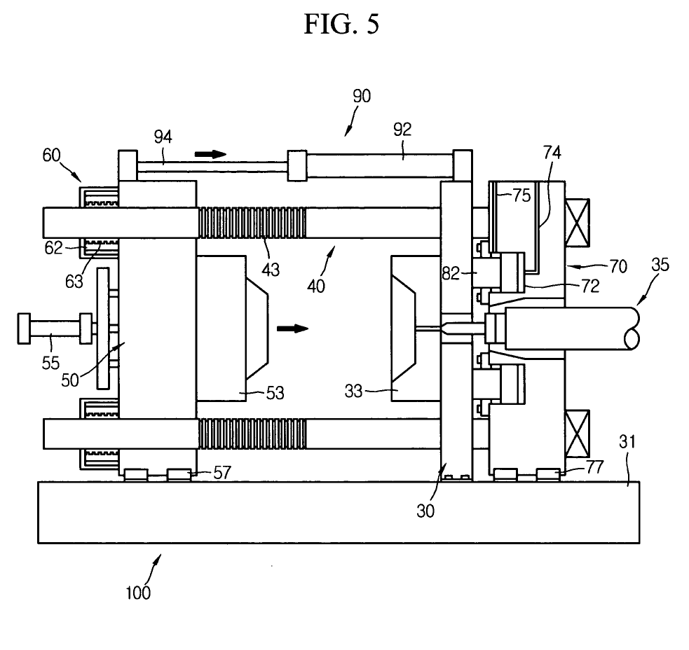

FIGS. 5 to 7 are side views showing how a hydro-mechanical clamping apparatus for an injection molding machine according to a preferred embodiment of the present invention is operated.

Referring to FIGS. 5 to 7, the hydro-mechanical clamping apparatus 100 for an injection molding machine includes a first fixed die plate 30 fixed to a frame 31, a tie bar 40 installed through the first fixed die plate 30, a moving die plate 50 slidably installed to the tie bar 40, a coupling unit 60 for coupling the moving die plate 50 and the tie bar 40, a second fixed die plate 70 installed at the front of the first fixed die plate 30 on the center of the first fixed die plate 30, and a piston ram 82 installed to the second fixed die plate 70 to selectively control a distance between the second fixed die plate 70 and the first fixed die plate 30.

The first fixed die plate 30 is fixed to the frame 31. A first half mold 33 comprising a part of a mold is mounted to the first fixed die plate 30, and an injection member 35 for injecting a melt resin is also mounted to the first fixed die plate 30. The injection member 35 is commonly used in an injection molding machine.

The moving die plate 50 is installed to one side of the tie bar 40, and the second fixed die plate 70 is installed to the other side of the tie bar 40. The moving die plate 50 and the second fixed die plate 70 will be described in more detail later.

At a predetermined region of the tie bar 40, a second tooth 43 selectively engaged with a first tooth 63 of a half nut 62 is formed. The second tooth 43 is selectively engaged with the first tooth 63 to fix the moving die plate 50.

The moving die plate 50 is mounted to the tie bar 40 to be capable of sliding thereon. A second half mold 53 is mounted to the moving die plate 50. The second half mold 53 comprising the remaining part of the mold and has a configuration corresponding to the first half mold 33.

An ejecting member 55 is installed to the moving die plate 50. The ejecting member 55 is also called an ejector, which is used for separating a product from the mold after the product is shaped. The ejector 55 is widely used in the injection molding machine, and not described in detail here.

The coupling unit 60 selectively couples the moving die plate 50 and the tie bar 40.

Preferably, the coupling unit 60 includes a half nut 62 mounted to the moving die plate 50, and a driving unit (not shown) for selectively reciprocating the half nut 62. The driving unit may be configured using a hydraulic cylinder or the like.

The half nut 62 has a first tooth 63 of a certain shape formed on its inner side. The half nut 62 is selectively reciprocated with respect to the tie bar 40 by means of the driving unit, that is a hydraulic cylinder or the like.

The second fixed die plate 70 is installed at the front of the first fixed die plate 30.

The clamping cylinders 72 are installed to the second fixed die plate 70. A piston ram 82 is mounted to the clamping cylinder 72, and oil ports 74 and 75 are respectively formed at the front and rear portions of the piston ram 82 for the supply of pressurized oil. A front end of the piston ram 82 is coupled to the first fixed die plate 30. The piston ram 82 closely adheres the second half mold 53 and the first half mold 33, mutually approached near by a carrying member 90, to each other to give a predetermined pressure to the molds 33 and 53 and thus generate a clamping force. The carrying member 90 will be described in more detail later.

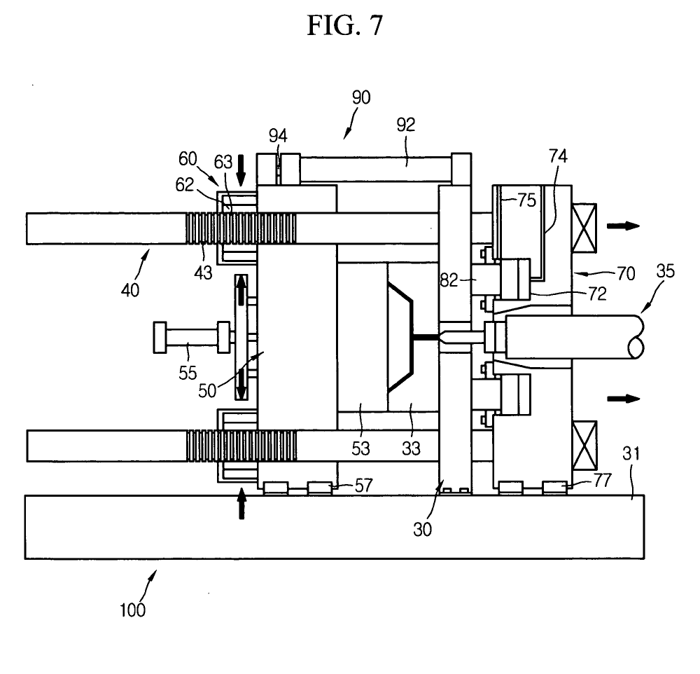

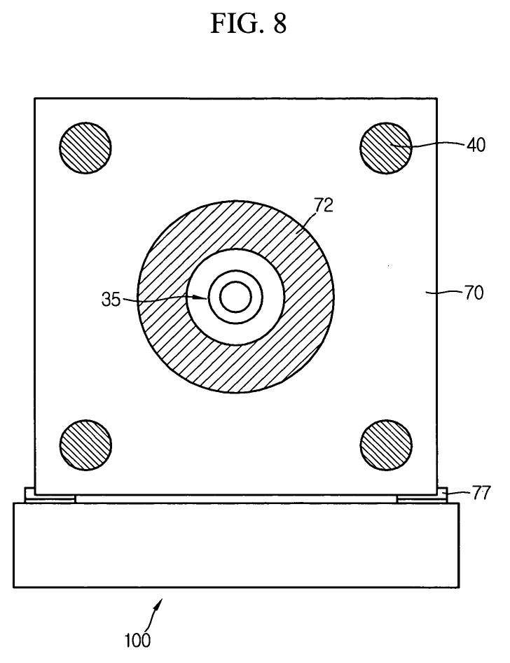

That is to say, as shown in FIG. 7, a pressurized oil is supplied to the front of the piston ram 82 through the front oil port 74 so that the second fixed die plate 70 is moved forward and thus the second half mold 53 and the first half mold 33 are closely adhered to each other. In addition, a pressurized oil is supplied to the rear of the piston ram 82 through the rear oil port 75 so that the second fixed die plate 70 is moved rearward and thus the second half mold 53 and the first half mold 33 can be separated from each other.

As mentioned above, the clamping apparatus 100 may easily obtain a desired clamping force by means of a simple structure that needs just supplying a pressurized oil to the clamping cylinder 72.

The piston ram 82 is used for closely adhering the second half mold 53 and the first half mold 33, already approaching nearly by means of the carrying member 90, to each other, so its movement distance is relatively very short. Thus, the clamping apparatus 100 requires a very small amount of pressurized oil, and its energy consumption is also very low. That is to say, the clamping apparatus 100 may effectively enhance a clamping force of the first and second half molds 33 and 53 just using a very small amount of pressurized oil and energy consumption.

As mentioned above, the clamping apparatus 100 of the present invention may apply a uniform clamping force to every portion of the first and second half molds 33 and 53 since the piston ram 82 directly presses the rear side of the first fixed die plate 30 to which the first half mold 33 is mounted. That is to say, since a uniform clamping force is applied to every portion of the first and second half molds 33 and 53, it is possible to prevent breakdown of the first and second half molds 33 and 53 and also produce products of high quality.

In addition, the clamping apparatus 100 may be easily applied to a large-sized injection molding machine that requires a great clamping force.

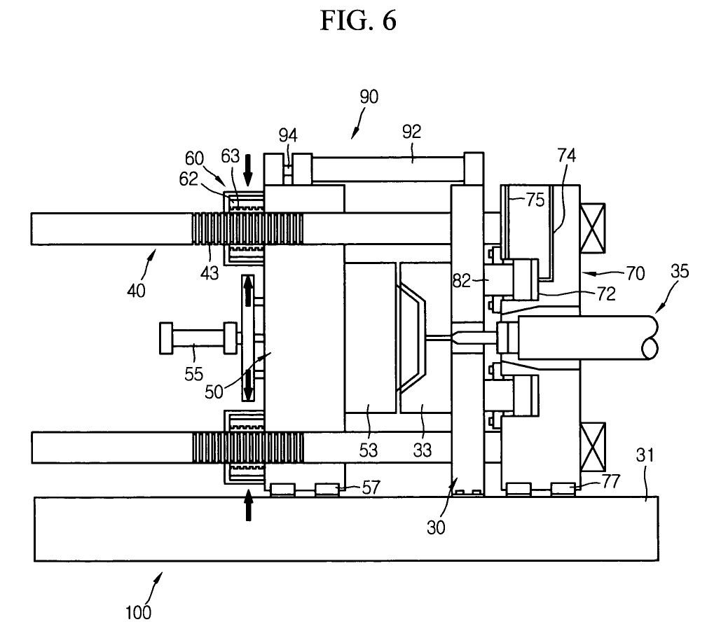

Preferably, the clamping apparatus 100 includes the carrying member 90 for moving the moving die plate 50 to approach the first half mold 33. FIG. 6 shows that the moving die plate 50 is moved by means of the carrying member 90. The number of carrying members 90 may be suitably selected in consideration of structure and size of the clamping apparatus 100.

More preferably, the carrying member 90 includes a cylinder 92 installed to the first fixed die plate 30, and a piston ram 94 mounted to the moving die plate 50. That is to say, as the piston ram 94 reciprocates by means of hydraulic pressure or the like, the moving die plate 50 is reciprocated with respect to the first fixed die plate 30.

As mentioned above, the clamping apparatus 100 moves the second half mold 53 to rapidly approach the first half mold 33 by using the carrying member 90, and then makes the second half mold 53 and the first half mold 33 be closely adhered to each other by using the piston ram 82. That is to say, by dividing the step of carrying the moving die plate 50 for shape engagement and the step of increasing pressure of the first and second half molds 33 and 53, it is possible to reduce the cycle time for producing products.

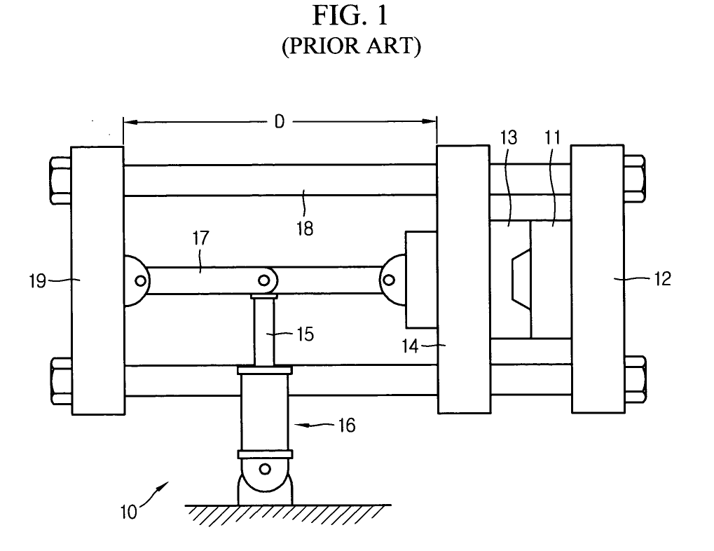

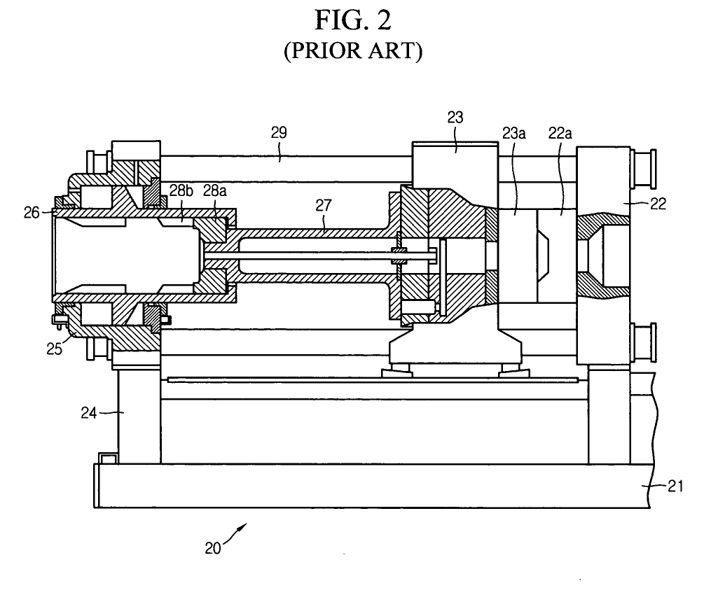

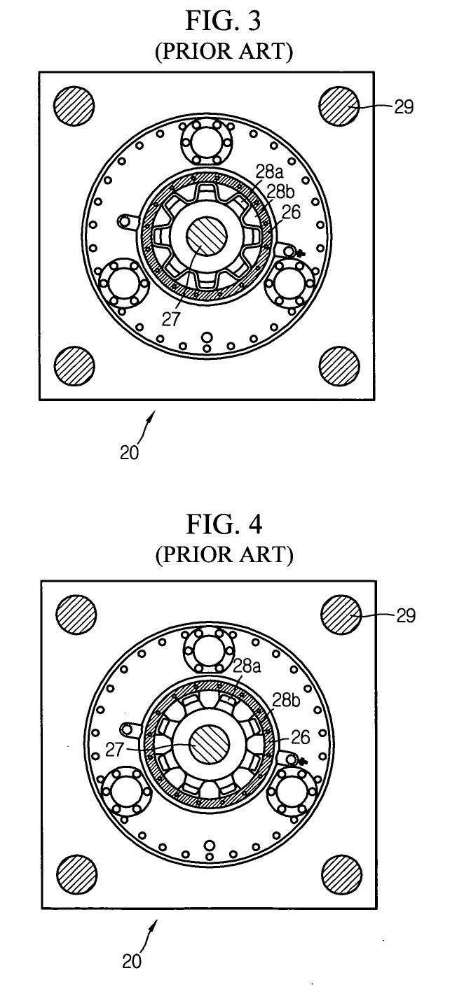

In addition, since the clamping apparatus 100 employs the carrying member 90 and the piston ram 82, there is no need to control a distance between the moving die plate 14 (see FIG. 1) and the support 19 (see FIG. 1) according to thickness of the molds 33 and 53 in case that the molds 33 and 53 are exchanged.

FIG. 8 is a sectional view showing that the clamping cylinder 72 is mounted to the second fixed die plate 70. The clamping cylinder 82 is prepared around the injection member 35. One piston ram 82 is installed to the clamping cylinder 72.

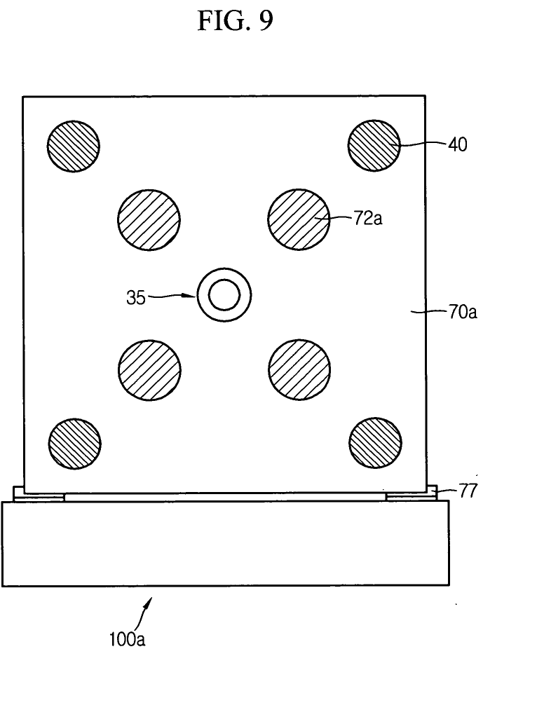

As an alternative, the predetermined number of clamping cylinders 72a may be prepared around the injection member 35 as shown in FIG. 9. That is to say, the number of the clamping cylinders 72a may be selected in consideration of size of the injection molding machine, magnitude of a required clamping force and so on. The piston ram is installed to each clamping cylinder 72a. The reference numeral 72a denotes a second fixed die plate, and 100a denotes a clamping apparatus.

Meanwhile, though FIGS. 5 to 9 show the clamping cylinder 72, 72a mounted to the second fixed die plate 70, 70a, the clamping cylinder may also be mounted to the first fixed die plate. That is to say, it is possible that the clamping cylinder is installed to the first fixed die plate, and a piston ram is mounted to such a clamping cylinder to selectively move the second fixed die plate so that the first half mold 33 and the second half mold 53 may be sealed or separated.

Now, the operation of the hydro-mechanical clamping apparatus for an injection molding machine according to a preferred embodiment of the present invention will be described in detail.

First, the carrying member 90 is operated to move the moving die plate 50 so that the second half mold 53 approaches the first half mold 33. After the second half mold 53 is moved near to the first half mold 33, the coupling unit 60 is operated to fix the moving die plate 50 and the tie bar 40. The half nut 62 is moved toward the tie bar 40 by means of hydraulic oil so that the first and second teeth 63 and 43 are engaged with each other. The supply of hydraulic oil may be accomplished by a control means (not shown).

Subsequently, the pressurized oil is supplied to the front of the piston ram 82 through the front oil port 74, and the supplied pressurized oil moves the second fixed die plate 70 backward slightly so that the second half mold 53 is closely adhered to the first half mold 33. Then, a melted resin is injected into the molds 33 and 53 through the injection member 35.

Meanwhile, if the resin is injected and then completely cooled, the pressurized oil is supplied to the rear of the piston ram 82 through the rear oil port 75. The pressurized oil supplied through the rear oil port 75 moves the second fixed die plate 70 forward so that the second half mold 53 and the first half mold 33 are separated from each other.

If the second half mold 53 and the first half mold 33 are separated a predetermined distance, the half nut 62 is moved in a direction opposite to the tie bar 40 so as to release the first and second teeth 63 and 43.

If the engagement between the first and second half molds 63 and 43 is released, the carrying member 90 is operated to move the moving die plate 50 backward.

### APPLICABILITY TO THE INDUSTRY

As described above, the hydro-mechanical clamping apparatus for an injection molding machine according to the present invention gives the following effects.

First, it is possible to effectively enhance a clamping force to the molds and reduce energy consumption with the use of a very small amount of pressurized oil.

Second, the apparatus may be easily applied to a large injection molding machine that needs a great clamping force.

Third, it is possible to easily obtain a desired clamping force with a simple structure.

What is claimed is:

1. A clamping apparatus for an injection molding machine, comprising:
a frame;
a first fixed die plate fixed to the frame and on which a first half mold is mounted;
a tie bar fixed to a second fixed die plate to guide a moving die plate;
the moving die plate slidably installed to the tie bar and on which a second half mold corresponding to the first half mold is mounted;
a coupling means installed to a rear side of the moving die plate and coupling the moving die plate to the tie bar;
the second fixed die plate installed to the tie bar at the front of the first fixed die plate; and
at least one piston ram installed between the first and second fixed die plates and selectively controlling a distance between the first and second fixed die plates so that the first and second half molds are closely adhered to each other or separated from each other.

2. The clamping apparatus according to claim 1, further comprising:
a carrying member for sliding the moving die plate so that the second half mold approaches the first half mold.

3. The clamping apparatus according to claim 2, wherein the carrying member includes:
a cylinder installed to the first fixed die plate; and
a piston ram installed to the moving die plate.

4. The clamping apparatus according to claim 1, wherein the coupling means includes:
a half nut installed to the moving die plate and having a first tooth of a predetermined shape formed on an inner side thereof; and
a driving unit for selectively reciprocating the half nut with respect to the tie bar,
wherein a second tooth to be engaged with the first tooth is formed on an outer circumference of the tie bar so that the first and second teeth are selectively engaged to couple the moving die plate to the tie bar.

5. The clamping apparatus according to claim 1,
wherein the piston ram is installed in a clamping cylinder mounted to one of the first and second fixed die plates, and
wherein oil ports are formed in the clamping cylinder so as to inject pressurized oil to the front and rear of the piston ram respectively.

6. A method for clamping an injection mold, comprising the steps of:
moving a first half mold mounted on a moveable die plate into the near vicinity of a second half mold mounted on a first fixed die plate;
fixing the moveable die plate to a structure coupled to a clamping cylinder; and
admitting pressurized oil into the clamping cylinder through a first oil port so as to apply pressure to a piston ram coupled to the first fixed die plate, thereby generating a clamping force and clamping the first half mold and second half mold together.

7. The method of claim 6 further comprising the step of admitting pressurized oil into the clamping cylinder through a second oil port on the opposite side of the piston ram, thereby separating the first half mold and the second half mold from each other.

8. The method of claim 7 further comprising the steps of:
releasing the moveable die plate from the structure; and
moving the first half mold away from the second half mold.

9. The method of claim 6 wherein the structure coupled to the clamping cylinder comprises a tie bar and a second fixed die plate.
